(19) United States
(12) Patent Application Publication
(10) Pub. No.: US 2001/0049671 A1
(43) Pub. Date: Dec. 6, 2001

(54) e-Stract: a process for knowledge-based retrieval of electronic information

(76) Inventor: Werner B. Joerg, Salt Lake City, UT (US)

Correspondence Address: WERNER B. JOERG, 1246 RODEO LANE, SALT LAKE CITY, UT, 84121, US

(21) Appl. No.: 09/874,822

(22) Filed: Jun. 5, 2001

Related U.S. Application Data
(60) Provisional application No. 60/209,185, filed on Jun. 5, 2000.

(51) Int. Cl. G06N 5/02; G06F 17/00; G06F 7/00; G06F 17/30

(52) U.S. Cl. 706/50; 707/3

(57) ABSTRACT

This invention addresses the problems of current search techniques on the Internet—volume, ranking, difficulty to assess—and extends the solution to all kinds of electronic information accessible through networks and databases. The solution principle engages the help of specialists in particular domains and supplies them with tools to effectively scour the information resources for high quality information in their field, to commit that knowledge to distributed databases, to construct dedicated knowledge environments, and to submit corresponding context information to centralized registries. End users implicitly access mirrored services of these registries and use the context information to focus their searches onto the resources qualified by the expert network. Many of the individual techniques involved in building the tools for deployment, operation and exploitation of such “Networks of Qualified Knowledge” are well known and may in the future be replaced by more effective techniques. The essence of the invention lies in the way these techniques are put to use to implement the presented process.

### CROSS-REFERENCE TO RELATED APPLICATIONS

This application claims priority from the provisional application (No. 60/209,185) filed Jun. 5, 2000.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

1. Technical Field

The present invention relates to a process and computer methods for extracting knowledge, in particular context information, from distributed electronic information. It involves fuzzy logic for classification and uses reverse indices for context corroboration. It promotes the merging of knowledge and interaction towards collaborative problem solving using dedicated knowledge environments. It relies on distributed programming techniques to deploy virtual networks for context-directed access to such environments.

2. Prior Art

There is a vast and ever increasing amount of information available in electronic form through computer networks. The World Wide Web has evidenced this point to the excess and has shown also its major flaws: the “right” information is difficult to spot in large amounts of search results, and if some document “looks” good, one may still not be in a position to assess its quality and it is difficult to locate other “surfers” with similar interests for a “chat”. These problems are exacerbated by the fact that search engines are “bribable” (i.e. he who pays gets on top), directories have generally poor coverage, and above all: searches are performed on a key term basis—when users are looking for documents that talk “about” a certain topic, the term of that topic may not even appear in the best documents. Furthermore, since searching is rarely done without a purpose, one can assume that problem solving is at the root of the task, and since nowadays many problem solving tasks are team activities, another fundamental deficiency of current search techniques emerges: there is no way to tie information and means for interaction dynamically together at the time of searching. My invention takes a radically different approach to these problems, by engaging the help of large numbers of specialists in particular domains and supplying them with tools to effectively scour the net for high quality information in their field, to commit that knowledge to distributed databases, and to submit corresponding context information to centralized registries. End users implicitly access mirror services of these registries and use the context information to focus their searches onto the resources qualified by the expert network. Many of the individual techniques involved in building the tools for deployment, operation and exploitation of such “Networks of Qualified Knowledge” are well known and can be readily found in current computer literature—they may be replaced by more effective techniques in future implementations. The essence lies in the way these techniques are put to use to implement the presented process.

### BRIEF SUMMARY OF THE INVENTION

The invention enables users of networked computer services to retrieve select distributed electronic information, using context-directed searches. Said searches evolve transparently, in parallel over virtual networks of nodes that host qualified knowledge about information of interest. The underlying process covers the construction and populating of such nodes, their amalgamation into such searchable networks, and the targeted distribution of associated services within a consistent framework.

### BRIEF DESCRIPTION OF THE SEVERAL VIEWS OF THE DRAWING

[Rectangles indicate actions (sub-processes); rounded rectangles indicate data storage; clear ellipses represent human roles; solid lines show the flow of program control; dotted lines show the flow of data and user action. The numbers associated with the various rectangles and ellipses are used for reference in the text.]

FIGS. 1 and 2 show the top-level architecture of the principal components of the e-Stract process.

FIG. 1 illustrates the knowledge acquisition part (EX-Stract) of the process.

FIG. 2 illustrates the knowledge enrichment (AB-Stract) and distribution (Context Routing and VUe-Stract) parts of the process.

FIG. 3 shows the details of the Origination sub-process.

FIG. 4 shows the details of the Extraction sub-process.

FIG. 5 summarizes the activities involved in the Qualification phase.

FIG. 6 illustrates the virtual network topology of Networks of Qualified Knowledge.

### DETAILED DESCRIPTION OF THE INVENTION

This invention relates to a process implementable as interacting programs/program components, distributed over computer networks, with the effect of making select information retrievable through knowledge-based mechanisms on a broad scale.

The process applies to information held in local or distributed electronic documents of any type (“Knowledge Resources”), which can be accessed through electronic paths such as directory paths, URL's (Uniform Resource Locator) or database requests. Knowledge-based retrieval in this context encompasses the origination, knowledge extraction from such documents and their qualification, as well as their elucidation and distribution of knowledge gained about them, in concert with targeted access to, and display of, the original documents.

Origination deals with the source and type of the documents. Extraction derives knowledge by analyzing their content and relevance, and determining their classification. Qualification assesses the quality and significance of a document by using filtering, inspection and annotation. Elucidation provides for the creation of dedicated knowledge presentation environments by domain experts. Distribution warrants efficient and controlled access to the recorded knowledge by the targeted users.

e-Stract is a process that integrates instances of these tasks into a consistent framework for context-driven management of knowledge about qualified documents. This process constitutes a comprehensive approach to Networked Knowledge Management. At the time of this writing, most components have been implemented as proof of concepts; no actual large-scale deployment has yet been undertaken, however, and the notion of “knowledge” has been limited to “context” information, that is, determination/approximation as to the context(s) in which a document or portions thereof evolve.

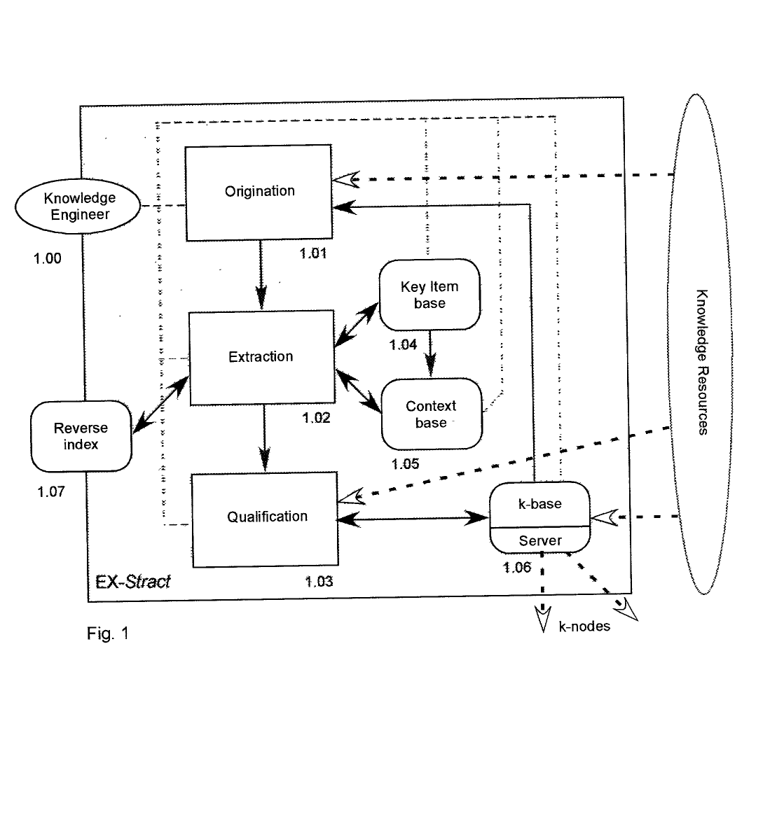

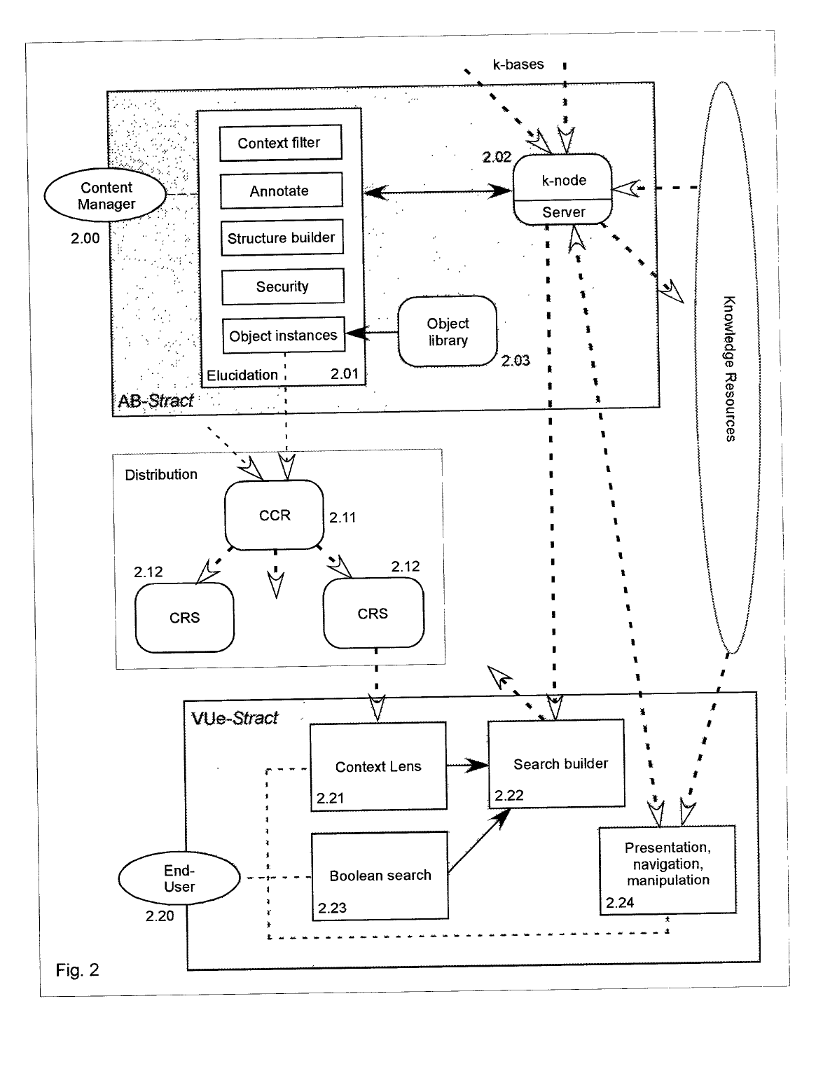

The top-level architecture of the principal components of the process is shown in FIGS. 1 and 2:

FIG. 1 illustrates the knowledge acquisition part (EX-Stract) of the process, with its main components Origination, Extraction and Qualification. It shows also their connectivity to data services such as the Key item base (akin to a dictionary), the Context base (which holds the context definitions and descriptions), the Reverse index (which records the locations that point to select documents), and the knowledge base which records the acquired and qualified knowledge.

FIG. 2 illustrates the knowledge enrichment and distribution part of the e-Stract process. The Content Manager uses AB-Stract to select appropriate material from one or more k-bases, to annotate it, to structure it and to build a knowledge distribution environment, complemented with interactive services, for a target audience. The diagram illustrates how objects from the resulting k-node are submitted to the CCR, which then distributes the corresponding context information to the routing service (CRS). The figure shows also how the end-user interfaces implicitly with the routing service (via the Context Lens in VUe-Stract).

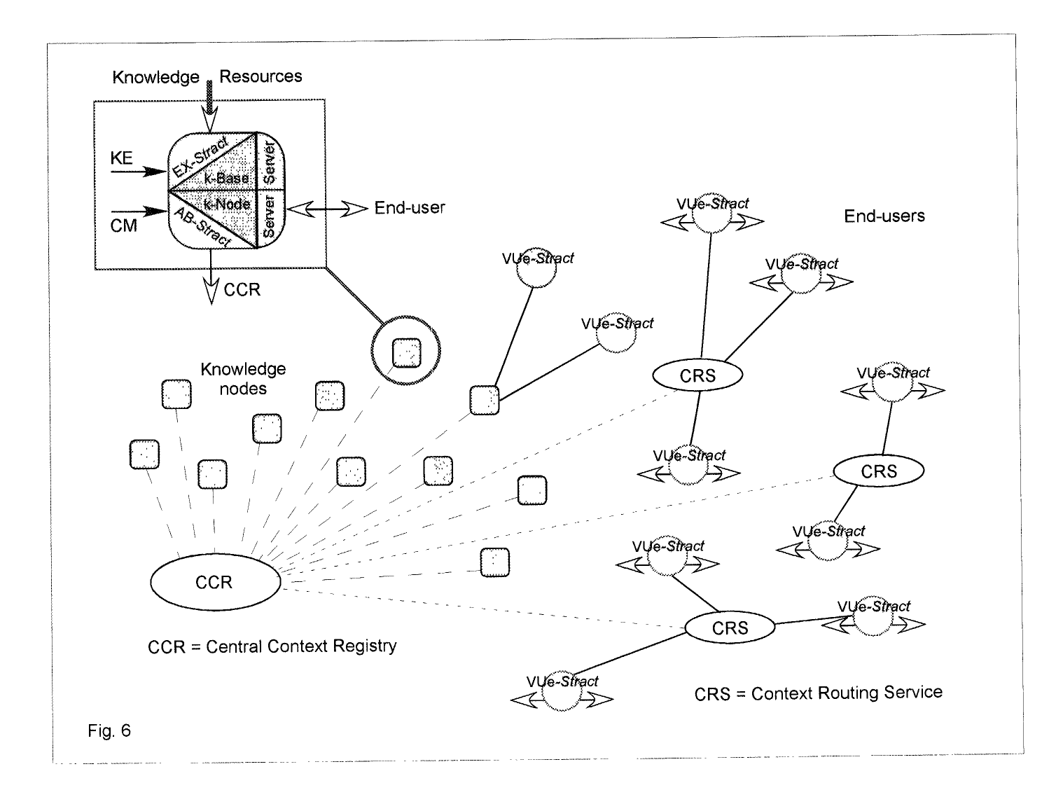

In FIG. 6 the virtual network topology of Networks of Qualified Knowledge is shown, connecting Knowledge Nodes via CCR (Central Context Registry) and CRS (Context Routing Service) for the end-user. The details of the knowledge node are symbolized as a rounded rectangle with the services (EX-Stract and AB-Stract respectively) available to the KE (Knowledge Engineer) and to the CM (Content Manager) and the servers servicing the knowledge base (k-base) and the knowledge node (k-node). The end user's viewer (VUe-Stract) is connecting implicitly to a CRS when search requests are initiated, the context information provided by the CRS is then used to direct the requests to the k-nodes most likely to deliver appropriate information—this is symbolized by the double arrows attached to the viewers. The diagram shows also viewers connecting directly to knowledge nodes to use other services offered by the knodes.

Origination [1.01]: documents of interest may be referenced in many different ways—as bookmark lists [1.01.08], as lists compiled from search engines [1.01.09], as graphs generated by hyperlink sequences [1.01.10], as directory hierarchies, as database requests [1 01 07], or any combination thereof. The mechanisms used to generate such collections of references are recorded as Search tasks [1.01.06] that can be invoked at any time or on programmable schedules. Particular lists are generated also on demand or periodically for verification, review and updating of previously recorded knowledge by database update bots [1.01.05]. Such bots are autonomous programs that monitor the usage of the database content and generate the review lists according to timing parameters or algorithm selection (e.g. LRU, MRU) specified by the operator [11 01.02]. Documents may exhibit any single type (e.g. text, image, sound), collections of a same type (e.g. newsgroup. video) or aggregates of various types (e.g. html, XML). e-Stract may record individually addressable components of collections and aggregates as separate entities, if required for qualification or retrieval purposes, from entire documents down to individual entries in interactive sessions. The results of the Origination process are queued in a “Document Queue” [1.01.11] where duplicate requests within the queue are being removed.

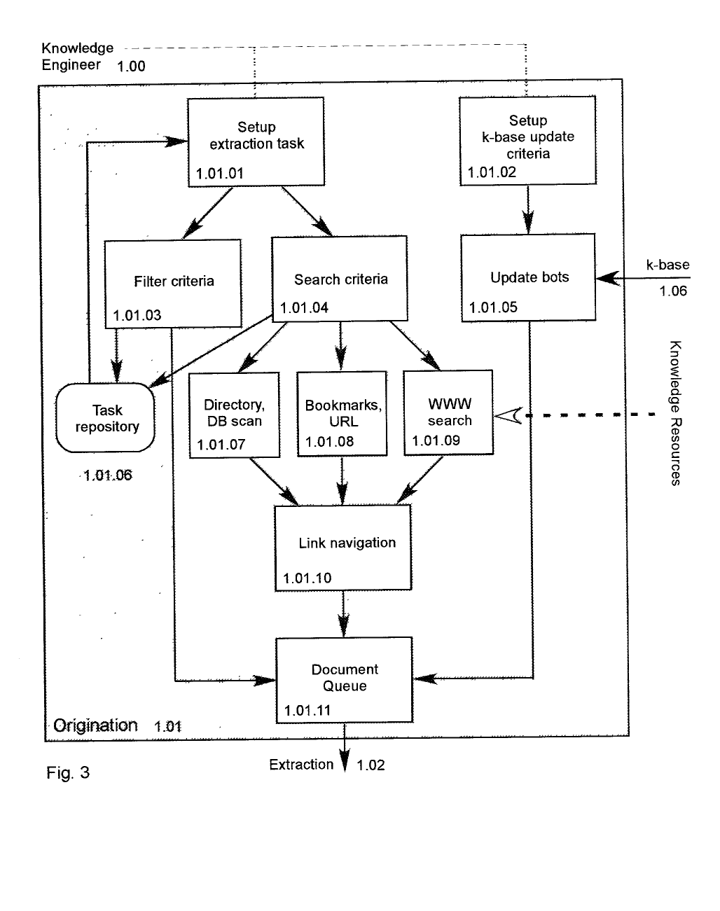

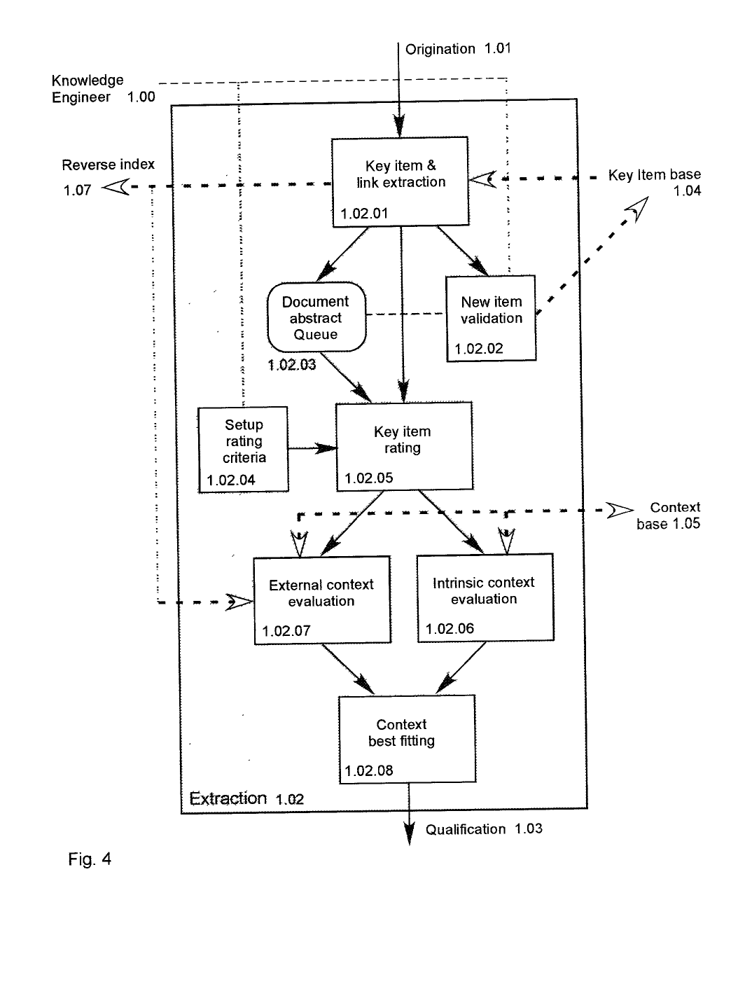

FIG. 3 summarizes the above details of the Origination sub-process: the operator (KE) interacts with this part by setting up the extraction tasks (i.e. defining the search criteria and the filter criteria) and by setting up the operating parameters for the k-base update bots. Extraction tasks can be stored and scheduled at will, thus allowing for automation of repetitive tasks. Note that the filter criteria are attached to the documents: they will be used only after completion of the context elaboration phase (see FIG. 4). This diagram shows also the various types of document origins that e-Stract may handle and the option to follow links in documents for further analysis.

Extraction [1.02]: the extraction task relies on the notions of key items (also concepts), contexts and context filters. Key items are terms, phrases, shapes, sequences or patterns identified as relevant for a given document; they are characteristic for the content and the meaning of a document. e-Stract maintains a dictionary of Key items [1 04], that records relevant items, items to be ignored and frequently misspelled items. Contexts are key items, deemed relevant for specific knowledge domains; they are characterized by fuzzy sets over key items (context sets for short), i.e. as sets of weighted key items where the weight rates the probability of the item to appear in a document referring to that context. e-Stract provides for manual and computer-assisted generation of context definitions [1.06]. Contexts are the classification keys for a document. It should be noted that context terms do not necessarily appear in the referenced document and that documents are rarely written in a single context; it is therefore appropriate to characterize the domain of discourse of a document by a fuzzy logic expression where the AND operator relates dependent contexts and the OR operator suggests juxtaposition of contexts. We refer to these expressions as classification expressions. In the e-Stract process, key items and contexts are continuously refined and revised as more documents are being analyzed. It is a main design goal to automate most of this part of the e-Stract process—expert human interaction nevertheless, must be part of the validation of the resulting successive enrichment. Context sets may contain key items that are contexts themselves. They cause a transitive relationship and hence induce graphs to which we refer as context graphs. These graphs are used extensively in the distribution part of the process (see below [2.21]). e-Stract distinguishes between intrinsic contexts [1.02.06] and external contexts [1.02.07] of a document. Using lexical analysis (text) or pattern analysis (image, sound . . . ) it [1.02.01] generates first a document abstract [1 02 03] that records the document structure, the hyperlinks and the occurrences of key items. The intrinsic context is obtained by evaluating the document abstract: known key items and their distribution in the document are used heuristically to estimate their relevance (weight) for the document. (A number of rating criteria can be considered at this stage but they are of no significance to the description of the e-Stract process, even though their performance may affect the outcome of the process.) What is of essence here is that each key item is associated with a weight factor. The occurrence patterns of weighted key items can then be used in three ways. (i) Context matching, i.e. infer a fuzzy logic expression from matching context sets to document sections and the overall document, or (ii) context induction, i.e. derive context sets through “normalization” of key item patterns for blank external contexts, or (iii) context fitting, i.e. adjust existing context sets through best fitting of key item patterns. A priori knowledge about the documents being analyzed and the degree of completion of the context descriptions for a given knowledge domain, guide the operator in the selection of the method to apply. Context matching is the normal operating mode: when a sufficiently large set of context definitions/descriptions is established, the program seeks the best matching context descriptions and calculates a factor proportional to the closeness of the matching. Context induction is a priming tool for context information: it is applied when reference documents are being analyzed in order to fill (empty) context definitions with suitable descriptions. This phase relies on expert human intervention, deciding which pattern suggestions of the program should be associated with which context definitions. Context fitting is the tool of choice during the building phase of context information: it is applied when documents from reliable sources are being analyzed. The referral knowledge of a document consists of its hyperlinks and a (not necessarily symmetrical) window of key items in the vicinity of each link. In order to find such referral knowledge we use reverse indices [1.07], i.e. data structures that record the location of documents referencing a given document—such indices can be licensed or maintained by e-Stract. This latter option is attractive once e-Stract is in wide use: a network of cooperating (Extraction) programs will jointly maintain a central Reverse Index by submitting all non self-referential references they extract. If access to the reverse index for referral knowledge processing becomes a performance bottleneck, the index may have to be mirrored. Referral knowledge can be used (a) to discover new (blank) context items and (b) to infer likely contexts of the targeted documents. e-Stract uses these key items as candidates for external contexts of the documents targeted by the links. The external domain of discourse of a document is a fuzzy expression in external contexts; it is therefore characterized by the referral knowledge of all the documents that point at it. The frequency of occurrence of context terms across all referencing documents determines likely candidates for external contexts with their corresponding weights. The knowledge acquired about intrinsic contexts and external contexts of a document can now be used to consolidate the knowledge about the document by best fitting [1.02 08]. Following situations are being considered.

(1) External context terms and intrinsic context terms match—the weights are balanced across all terms, in relation to the external and intrinsic relevance rankings. (2) Intrinsic context terms have no external matching—flag and accept as is. (3) External context terms have no intrinsic matching—present terms with entire selection of nameless intrinsic sets and suggest for manual set allocation. (4) Remaining nameless intrinsic sets—find closest matches in existing named sets and suggest for manual name allocation. This mechanism is at the root of successive adaptation of contexts evolving over time, and it forms the conceptual basis for automated context learning.

FIG. 4 shows a graphical summary of the Extraction sub-process. The goal of this phase is the best possible determination of the context(s) of any given document and then filter out the documents that do not meet the operator's filter criteria. As side effect, the process produces link information for the reverse index, and successive enrichment of both the Key item base and the Context base. Items that are identified as potentially interesting (heuristics) but can not be found in the Key item base are submitted to the operator for validation; [note that documents with pending validation requests are queued]; evaluation of external and internal contexts may refine or create entries into the Context base.

Qualification [1.03]: Significance and quality assessments are performed in two steps (a) filtering [1.03.01] and (b) inspection [1.03.02]. Once the knowledge extraction phase is completed, the document is checked against a context filter. Context filters consist of a fuzzy logic expression over named/unnamed context sets (using the standard operators AND, OR and NOT), paired with a threshold parameter and other constraints (e.g. type of documents, date last modified, author . . . ). [Note: the NOT operator is used to formulate exclusions of subsets, rather than negations, i.e. “this documents relates to apples, but not green apples”, rather than “this document does not relate to green apples”—which obviously cover different sets. It is therefore more likely to appear in context filters, which express specific limitations, rather than in automatically generated classification expressions for a domain of discourse]. The fuzzy logic expression delimits an ncube in the key items space. Documents contained within that space are considered a fit; for all others a distance function (absolute norm) is used to determine the proximity to the cube and the threshold parameter acts as cut-off value. If the document fails the thresholds, it is rejected; if it passes, it is queued for possible human inspection and annotation. Human inspection [1 03 02] consists of a review of the extracted knowledge (recorded in knowledge records—or k-records), and a visual inspection of the referenced document. The Knowledge Engineer may annotate the records [1.03.03] with comments pertaining to the raw knowledge of documents (e.g. reliability of the source, completeness, accuracy, etc. . . . ). Such annotations are displayed jointly, whenever the corresponding document is accessed via e-Stract. After completion of the qualification step, the k-records are successively committed [1.03.03] to a knowledge base or k-base [1 06]. In case of duplicate records, the operator may choose to discard either or, or merge.

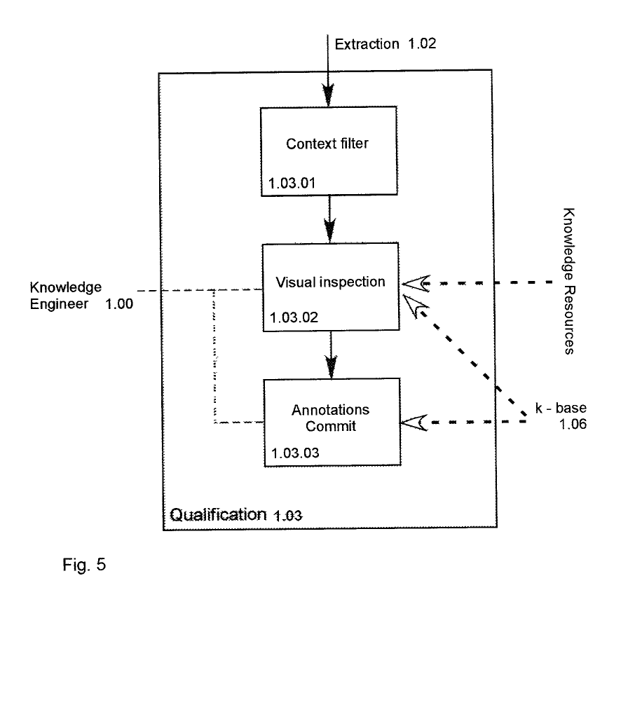

FIG. 5 summarizes the activities involved in the Qualification phase. The k-records supplied by the Extraction process are tested against the context filter (it's parameters are defined at the time of Extraction task setup). Records that do not meet the filter criteria are dropped; the remainder is presented for visual inspection of the extraction results and optional review of the corresponding document. The KE may also add annotations that will be presented any time a user retrieves the corresponding document via the k-base.

Documents that are being (re)analyzed as a result of a database bot request (review list) do not normally proceed through the qualification phase: after origination, documents that have become inaccessible cause a corresponding flagging of their k-record—if that flagging persists over an extended (operator adjustable) time period, the record is removed; after extraction, the results are compared to the k-record entries in the database—if there is “little change”, the record is updated automatically; if there is major change, the new and the old records are queued for the operator to qualify. In this context, “little change” refers to slight variations in context weighting (threshold may be operator adjustable); major changes include changes in context weighting above thresholds, as well as mismatch in sets of recorded contexts. [Note: For clarity, the path of review requests is omitted from the diagrams.]

Elucidation [2.01]: the above phases—Origination, Extraction and Qualification—are executed under the authority of a domain expert (Knowledge Engineer [1.00]), trained in the use of search tools and qualified to assess the relevance and quality of documents in specific knowledge domains. This sets the stage for the elucidation task, which caters to augmenting the knowledge acquired so far and to the creation of dedicated knowledge environments. It is executed under the authority of domain experts (Content Managers [2.00]), qualified to structure, comment and present domain knowledge to target audiences. Knowledge Engineer and Content Manager are distinct roles, relating to each other, like researcher and teacher; they may be held by a same individual, but at different times. The tools to create dedicated knowledge environments consist of a library of e-Stract objects [2.03] that provide particular items and services, and a structure builder [2.01] that allows to manipulate (create, move, alias, duplicate, group . . . ) object instances into graphs and hierarchies. Views are primitive objects; they form the basic containers for the structure builder, they can be nested or linked, and they can be displayed in different presentation formats (indented list, “tree”, 2D iconic panel, 3D spatial view . . . ), to underline roles such as book, collection, lens, etc. . . . The linking capability of views allows creating variants over common subsets of objects by offering different entry points. Open views can be adorned with embedded textual and graphical annotations. Collapsed views, like any instantiated object, are represented as icons (may vary with the presentation format). The e-Stract object library is a growing collection of templates for simple objects such as text panel, graphical canvas, k-record, URL, or context filter, and container objects such as chat, meeting, task list, announcement, conference, KM (Knowledge Management) tools and more . . . . The fundamental service of e-Stract lies in finding quality information; and since seeking information is frequently part of a problem solving task, and problem solving is often done in teams, the object library is geared to support collaborative problem solving. The ability to combine knowledge and means for interaction at any level is therefore a particular feature of the e-Stract process. Container objects hold sub-objects, instantiated objects become part of the knowledge base. Every object can be complemented with comments by Content Managers, and by end-users (subject to appropriate access rights)—such comments, being attached to the object handle rather than to the object itself, can be viewed without opening the object and give the end-user the option to skip documents without downloading. Also every object/sub-object is associated with a list of context terms, and hence can be processed through context filters, and of course, they are searchable in the traditional sense of Boolean key term search. The list of context terms is derived from the object's contents (e.g. through context matching—cf. (i) under Extraction) and may be adjusted by the Content Manager. As a result, populating views can be achieved in several ways—manipulation of existing objects (move, alias, copy), instantiations from the object library, or selections from context filtering and search results. This approach allows constructing environments with “dynamic” elements such as context filters [2.01], offering dynamic views into local and remote knowledge bases, and with more “static” elements such as web-books that contain not just static references to web pages, but also any other object such as chat, conference, or even context filter. By default, objects in a hierarchy inherit the context properties of the parent view. Since the e-Stract structure builder supports the construction of graphs, a same object may inherit different contexts, depending on the path along which it is being visited. Similarly, since objects inherit by default the security settings of their parent view, the access conditions of an object depend on the access path, unless it has been given a local access policy—more on this below.

Distribution [FIG. 2]: distributing the content of the knowledge nodes involves three principal components: context services, viewer and security. Context services consist of a central context registry (CCR) [2.11] and context routing services (CRS) [2.21]. Knowledge Engineers may grant (license) access to their k-bases (or part thereof) to select local or remote knowledge nodes. Content Managers create access paths to knowledge nodes through filter objects, books or searches [2.01]. As they build knowledge environments for their target audiences, they may also decide to make parts of their environments accessible to a larger public and submit a selection of their e-Stract objects to the CCR. Acceptance of the objects by the CCR is subject to quality control, conflict resolution in context descriptions and consistency checks of the associated contexts. Object registration is time limited: it is reviewed periodically and may be subject to periodical renewal/re-registration. Corresponding updates are dispatched to the CRS which relies on a set of distributed lookup tables placed on strategically selected hosts and complemented with access pointers located as close as possible to the end user. Such an approach is intended to set up an implicit routing infrastructure [similar to the pervasive Domain Name Service (DNS)]. The task of the CRS consists in efficiently presenting the available contexts to the end-user and reporting all registered e-Stract objects that match the user's selection. This combination of CCR and CRS induces virtual network structures over the Internet, linking knowledge nodes via the contexts of e-Stract objects. We refer to them as Networks of Qualified Knowledge (nQk). The viewer (VUe-Stract) [FIG. 2] is the end user's tool to access the services of knowledge nodes. It connects implicitly to the “closest” CRS and guides the user through a context selection/refinement process using a context lens [2 21] which can be “focused”, displaying the relevant e-Stract objects with varying sharpness, depending on the quality of the match. This context focusing process is directed by the context graphs that are induced by the submissions of e-Stract objects to the CCR. Results of this focusing step are transferred to the Search builder [222] which generates concurrent search requests for all k-nodes revealed by the lens. To further refine a selection of objects, VUe-Stract supports Boolean search [2 23] for key items this type of search is limited to the objects that fit the context requirements of the user. VUe-Stract presents context selection and search results as collection of object handles which can be previewed for comments by Content Managers and other users. It supports structural navigation through the object collection and, subject to proper access rights, enables the use of the services provided by e-Stract objects and invokes external applications that may be required for viewing specific document types [2 24]. The security mechanism manages the access protocols for groups and individuals, consistent with access rights established by the Content Managers for each node. e-Stract supports a combination of policy and security applicable at the level of individual objects, where policy determines generic access based on current rights of users, and security allocates/modifies rights based on user identity or group membership.

What I claim as my invention is a domain independent process to create, operate and exploit virtual networks of knowledge about electronic information of interest and associated services, retrievable through knowledge-based techniques, in particular through context information. This generic claim is detailed in the following 15 claims:

1. A process to create, operate and exploit Networks of Qualified Knowledge:
a. Said networks host knowledge about select electronic information (“document”) relevant to their domain of discourse.
b. Access to such knowledge is enabled through context-directed retrieval.
c. Said process facilitates the linking of quality information with means for interaction and collaborative problem solving.

2. A process to create knowledge about select electronic information. Said process includes:
a. Acquisition of raw information from a plurality of electronic information sources, including but not limited to, local and remote files and data directories, databases, Internet.
b. Extraction of Key items through analysis of the source information, to identify terms, phrases, shapes, sequences or patterns.
c. Pattern and distribution analysis of key items to determine role and relevance (“rating”) for each key item in the document.
d. A fuzzy-logic based technique to derive intrinsic contextual information through matching of weighted key item patterns.
e. A vicinity technique to derive external contextual information from information sources that reference the document under consideration
f. A fitting technique that exploits the results of d. (intrinsic context) and e. (external context) to consolidate the context evaluation of the document considered and to enrich the set of context definitions.

3. A computer method implementing phase a. of claim 2 as an asynchronous tool available to one or more operators (“Knowledge Engineers”) locally or through a computer network with the following services:
a. A graphical user interface to define Extraction tasks as a combination of search criteria, extraction method and backend filters (context filters).
b. A technique to save, modify and restore such tasks for periodic or occasional execution.
c. Said search criteria include but are not limited to generic techniques (such as local/remote directory scans, “bookmark” files and other URL lists), customized techniques (e.g. to scan databases, launch search request through Internet search engines, meta search engines or Internet directories), and breadth of embedded link navigation.
d. Said extraction methods include but are not limited to “know it all” techniques such as “looking for known key items”, and to adaptive techniques such as NGrams and “looking for new key items”.
e. A collection of methods to perform the actual network scans and search launches as defined by the Extraction tasks. The results are added successively to a document queue.
f. A method to pre-scan all retrieved documents for non-self referential links and perform iterative navigation of the embedded links to the breadth as defined by the Extraction tasks, and add new references successively to the document queue.
g. A method to prevent duplicate entries into the document queue.
h. A graphical user interface to define database update tasks based on a choice of criteria such as fixed periodic intervals, most frequent use, least frequent use, and other.
i. A method to implement one or more “autonomous” bots, monitoring database usage and generating update lists according to the criteria set by the operator in said database update tasks.

4. A computer method implementing phase b. of claim 2, with the following services for, but not limited to, textual key items:
a. A dictionary of key items classified into items of interest, items to ignore and items frequently misspelled. Grammatical variations of items are recorded in rule form, to allow for limited grammatical analysis of documents.
b. A user interface to the dictionary to search, review and modify its contents (items and associated grammatical rules).
c. A method for remote access to dictionaries produced by other operators, for content initialization, update and exchange.
d. An optional reverse index database that records links to given documents. Such database may be local or remote.
e. A optional method that extracts non-self referential links and submits them to said reverse index.
f. A collection of user selectable methods consistent with phase d. of claim 3, to extract known key items of interest and new potential key items from the documents.
g. A user interface to alert the operator and enable user supported validation of new potential key items.
h. A method to record occurrences (distribution and frequency) of valid key items in a document abstract. Said document abstracts are queued on pending key item validations.

5. A computer method to implement phase c. of claim 2 with the following services:
a. A user interface to specify rating criteria. Said criteria may include, but are not limited to, folding the key item distribution with standard distribution functions. Width, symmetry and center are typical parameters for such functions. Said functions may extend over the entire document under consideration or fixed portions or relative portions thereof
b. A collection of methods that implement the allowable operator selections for rating criteria and that record the resulting value(s) in said document abstract.

6. A computer method to implement phases d., e. and f. of claim 2 with the following services:
a. A database (“Context base”) that holds context definitions (“name”) and context descriptions (fuzzy set in key items). Entries may consist of definition only (“named context”), description only (“un-named context”) or both (“defined context”).
b. A user interface to said context base to search, review and modify its content.
c. A method for remote access to context bases produced by other operators, for content initialization, update and exchange.
d. A set of 3 basic operating modes—priming, learning and normal operation. Said priming mode implies that the extraction process executes over one or more reference documents; said learning mode implies that the extraction process executes over a trusted set of documents; normal operation does not make any such assumption.
e. A set of methods and user interaction for priming operation: collections of extracted key items are presented for manual allocation to context definitions (“context induction”).
f. A set of methods and user interaction for learning operation: key item patterns are used to refine existing context descriptions (“context fitting”).
g. A set of methods for normal operation to match context descriptions from said context base to key item patterns in said document abstract. The methods support both matching of clustered patterns for localized context, and matching of document wide patterns for overall context. They support both non-subtractive and subtractive extraction (items that match a context are “removed” from the document abstract).
h. A method that retrieves referral knowledge from said reverse index or from a third party reverse index service. It locates all references pointing to the document under consideration within the documents addressed by such referral knowledge. It extracts key items in the “vicinity” of the references and attempts to match them (“external contexts”) to the intrinsic contexts or known context definitions. Depending on the operating mode (phase d. above) such matchings are used for automated context learning (refinement and extension).
i. A method to create a data structure (“knowledge record” or k-record) summarizing the findings from said document abstract.
j. A method to reconcile discrepancies between external and intrinsic contexts and record the best fittings in said k-record.

7. A process to enrich knowledge created through the process of claim 2. Said process includes:
a. Filtering of k-records to retain only records that match user defined context criteria. Said criteria are formally defined as fuzzy expressions over context definitions and warrant that minimum or maximum matching thresholds are met.
b. K-records that are not filtered out are submitted to the operator for inspection, optional annotation and committing to a database.

8. A computer method to implement claim 7, with the following services:
a. A database (“Knowledge base” or k-base) that holds the summarized information (k-record) about the documents of interest.
b. A server for remote access to the k-base by the distribution mechanism of the e-Stract process.
c. A user interface to search, review and modify the content of the k-base.
d. A method to filter k-records in accordance with the filter criteria set by the generating Extraction task (phase a. in claim 3).
e. A user interface to review and edit the content of k-records, to access the document referenced therein, to add annotations to the record and to commit the completed record. If the document is already referenced by a record in the k-base, the operator may delete/modify either, or merge them.
f. A method that identifies records generated by database update requests, bypassing the filtering mechanism and comparing the results with the current entries—small changes are updated automatically; large changes are presented to the operator through the interface e. above.

9. The embodiment realized through claims 3, 4, 5, 6, and 8 constitute a Knowledge Engineer's tool “EX-Stract”.

10. A process to elucidate knowledge recorded in k-bases. [Elucidation in this context deals with augmenting existing knowledge by structuring it, associating it with other knowledge, complementing it with means for interaction, and annotating it to form a knowledge node (k-node) for particular target audiences]. Said process includes:
a. Connectivity to qualified knowledge sources (k-bases and other k-nodes).
b. A toolset to build structured k-nodes as dedicated knowledge delivery environments.
c. A technique to control access to the resources of a k-node by individuals and groups.
d. Support for team-based problem solving.
e. Personalized remote visibility control of k-node resources

11. A computer method implementing claim 10, with the following services:
a. A collection of methods defining templates for items (e.g. container, text entity, graphic object, book) and services (e.g. chat, conference, meeting, file exchange) offered. Such templates are listed in the object library.
b. An access method to local and remote k-bases, paired with a context filter.
c. A collection of methods for the instantiation of templates as e-Stract objects and allocation of attributes such as context information and descriptive notes.
d. A collection of methods for the maintenance of user lists/group lists, allocation of access policies with individual objects, and association of objects and access rights.
e. An action permission scheme that limits individual operations of objects to selectable access rights.
f. A database (k-node) that holds the instances of e-Stract objects and their graph structure for access path validations.
g. A server for remote access to the k-node by end-users and other k-nodes.
h. An execution framework that supports concurrent access of end-users and operators under the constraints imposed by access rights and action permissions of individual objects.
i. A method to register select objects with a (centralized) registry (claim 13)
j. A user interface supporting all actions under this claim.
k. The embodiment of actions and interfaces under this claim constitute the Content Manager's tool “AB-Stract”.

12. A process to distribute k-node objects across a virtual network for context-directed retrieval. Said process includes:
a. A centralized submission mechanism for e-Stract objects characterized by their type and associated contexts. [Centralized does not mean unique: each Network of Qualified Knowledge may boast its own registry].
b. A distribution mechanism of submitted context information to end-users through computer networks.

13. A computer method implementing claim 12, with following services:
a. A database serving as (central) context registry (CCR), accepting submissions, verifying their validity, testing for consistency, maintaining corresponding context graphs and monitoring the periodical renewal.
b. A method (context routing service, or CRS) to distribute and periodically update context graphs to strategically positioned locations for efficient (implicit) access by end-users.

14. A process for context-directed retrieval of e-Stract objects and associated services. Said process includes:
a. A mechanism for implicit connection to the context network and efficient focusing on contexts of interest.
b. A mechanism to launch searches, optionally refined by Boolean expressions, on all (and only those) k-nodes that satisfy the given context conditions.
c. A mechanism to receive and display the results, and enable the available services.

15. A computer method implementing claim 14 with following services:
a. A “Context Lens” method that connects to the closest CRS, retrieves portions of the context graph as required by the end-user's successive choices. Upon completion of the choices, it requests pertinent node information from the CRS for the search builder.
b. A graphical user interface that shows the local connectivity between contexts and their “distance” from the current context. Said distance effect is achieved with shading and perspective. The interface provides controls for “zooming” and navigating along the context graph.
c. A user interface to specify searches (Boolean, key term based, or other constraints such as object type, dates) within the context space focused on with said context lens.
d. A search builder that uses the node information from said context lens and the Boolean search to launch concurrent searches on the nodes of interest.
e. A method to receive and present the search results to the end-user.
f. A user interface to display the search results; to support navigation through said results; and to access the k-node services associated with said results.
g. The embodiment of actions and interfaces under this claim constitute the Enduser's tool “VUe-Stract”.
